(19) United States
(12) Patent Application Publication
(10) Pub. No.: US 2025/0199202 A1
(43) Pub. Date: Jun. 19, 2025

(54) DEVICES AND METHODS FOR CONTROLLABLY REFLECTING ELECTROMAGNETIC WAVES

(71) Applicant: HUAWEI TECHNOLOGIES CO., LTD., Shenzhen (CN)

(72) Inventor: Senglee Foo, Shenzhen (CN)

(21) Appl. No.: 19/066,382

(22) Filed: Feb. 28, 2025

Related U.S. Application Data
(63) Continuation of application No. PCT/CN2022/116692, filed on Sep. 2, 2022.

(51) Int. Cl. G02B 1/00; G02B 5/32

(52) U.S. Cl. CPC G02B 1/002; G02B 5/32

(57) ABSTRACT

A device for controllably reflecting electromagnetic (EM) waves is provided. The device includes a metasurface having an array of electromagnetic unit cells. The device further includes a controller for controlling, based on an angle of incidence of the EM waves relative to the metasurface and based on a desired anomalous angle of reflection of the EM waves relative to the metasurface, a reflection phase of each unit cell of a supercell of the metasurface to control an angle of reflection of the EM waves relative to the metasurface to be the desired anomalous angle of reflection. The supercell consists of one or more of the unit cells, and a size (D) of the supercell in a direction of a plane of propagation of the EM waves is at least 2λ, wherein λ is a wavelength of the EM waves.

### CROSS-REFERENCE TO RELATED APPLICATION

The present application is a continuation of Patent Cooperation Treaty Application Serial No. PCT/CN2022/116692, entitled “DEVICES AND METHODS FOR CONTROLLABLY REFLECTING ELECTROMAGNETIC WAVES,” filed on Sep. 2, 2022, the entirety of which is incorporated by reference herein.

### FIELD

The present disclosure relates to the field of wireless communications, and in particular to methods and devices for controllably reflecting electromagnetic waves.

### BACKGROUND

Advanced cellular communications generally seek to improve both spectral and power efficiency. One approach for achieving these aims is to distribute a large number of reconfigurable reflecting surfaces on readily available, high-rise reflective surfaces to increase channel efficiency without requiring the use of additional, complex, and expensive active base station arrays. This approach can potentially lead to improvement of channel efficiency without a corresponding increase in power consumption. Such setups have been referred to as extremely large aperture arrays, or large intelligent surfaces. The success of these concepts, however, requires a new class of software-controllable antenna technology that is able to implement wide-angle, low-profile, low-cost, anomalous electromagnetic wave reflections.

One example of a prior art anomalous reflector is described in A. Diaz-Rubio, V. S. Asadchy, A. Elsakka, and S. A. Tretyakov, “From the generalized reflection law to the realization of perfect anomalous reflectors”, https://www.researchgate.net/publication/308647574, 2017. In this case, directive power transfer along the metasurface was achieved by tuning phase synchronization of the free-space waves and the leaky-waves on the surface.

However, issues with this leaky wave antenna include the fact that it is not easily reconfigurable since, when the angles of incidence and reflection are changed, the surface impedances need to be reconfigured through complex mathematical computations. Furthermore, no general surface pattern can accommodate any given incidence-reflection conditions. And still further, the angle of separation between the angles of incidence and reflection is relatively narrow and limited to 70°.

### SUMMARY

According to a first aspect of the disclosure, there is provided a device for controllably reflecting electromagnetic (EM) waves, comprising: a metasurface comprising an array of electromagnetic unit cells; and a controller for controlling, based on an angle of incidence of the EM waves relative to the metasurface and based on a desired anomalous angle of reflection of the EM waves relative to the metasurface, a reflection phase of each unit cell of a supercell of the metasurface to control an angle of reflection of the EM waves relative to the metasurface to be the desired anomalous angle of reflection, and wherein the supercell consists of one or more of the unit cells, and wherein a size (D) of the supercell in a direction of a plane of propagation of the EM waves is at least 2λ, wherein λ is a wavelength of the EM waves. Therefore, incoming EM waves may be controllably and anomalously reflected over a relatively wide separation angle. D may be equal to λ/|sin θ⁰|, wherein θ⁰ is the angle of incidence the EM waves relative to the metasurface. Therefore, the size of the supercell (and accordingly the number of unit cells whose reflection phases are controlled) may be adjusted based on the angle of incidence the EM waves relative to the metasurface.

Controlling the reflection phase of each unit cell of the supercell may comprise determining

$$H = \frac{2 π nd}{λ} \cdot [ 1 + \frac{cos ( θ + β )}{cos ( θ - β )} ] [ \frac{sin β}{cos θ} ] ,$$

wherein: H is a phase hologram representing an average reflection phase at a center of each unit cell of the supercell; d is an inter-element spacing separating adjacent unit cells of the supercell; n is a positive integer; β is an angle between the metasurface and a virtual reflective surface, wherein the virtual reflective surface is a reflective surface wherein, if the EM waves were incident on the reflective surface, the EM waves would be reflected in a same direction as the EM waves are to be anomalously reflected off the metasurface; and θ is, if the EM waves were incident on the reflective surface, a specular angle of reflection of the EM waves relative to the reflective surface. Therefore, the reflection phase of each unit cell of the supercell may be controlled based on a phase hologram that is calculated as a function of the angle formed by the metasurface and the virtual reflective surface.

Each unit cell of the supercell may comprise one or more artificially engineered structures for interacting with the EM waves. In this context, it shall be understood that only one or more of the unit cells of the supercell may comprise one or more artificially engineered structures for interacting with the EM waves, while one or more other unit cells of the supercell do not comprise such artificially engineered structures.

The one or more artificially engineered structures may comprise one of more of: a liquid crystal loaded dielectric material; a microelectromechanical system (MEMS); and a semi-conductor for electronic phase adjustment. Such artificially engineered structures may enable the reflection phase of each unit cell to be controlled very rapidly, thereby enabling substantially instantaneous reconfiguration of the metasurface.

A size of each unit cell of the supercell may be less than λ/4.

The controller may be operable, based on the angle of incidence of the EM waves relative to the metasurface, and based on the desired anomalous angle of reflection of the EM waves relative to the metasurface, to control the reflection phase of each of first unit cells of the unit cells, and each of second unit cells of the unit cells, so as to control the angle of reflection of the EM waves relative to the metasurface to be the desired anomalous angle of reflection; the first unit cells define a first row of one or more first supercells, each first supercell comprising one or more first unit cells; the second unit cells define a second row of one or more second supercells, each second supercell comprising one or more second unit cells; and the first row of one or more first supercells is, in the direction of the plane of propagation of the EM waves, offset by an offset distance from the second row of one or more second supercells. By offsetting adjacent rows of supercells, significantly improved sidelobe performance may be achieved. This approach to controlling the reflection phases of the unit cells of multiple supercells may be a particular implementation of the more general concept of controlling the reflection phases of the unit cells of one or more supercells (as described above in connection with the first aspect of the disclosure). In other words, the controller may control the reflection phases of unit cells of a single or multiple supercells of the metasurface.

The offset distance may be less than half a size of the supercell in the direction of the plane of propagation of the EM waves, and less than λ.

Controlling the reflection phase of each first unit cell and each second unit cell may comprise determining the reflection phase of each unit cell of each first supercell and each second supercell based on the offset distance. By adjusting the reflection phase of each unit cell based on the offset distance, sidelobe reduction may be achieved without significantly affecting the main-lobe gain.

A separation angle between the angle of incidence of the EM waves relative to the metasurface and the desired anomalous angle of reflection of the EM waves relative to the metasurface may be at least 120°.

According to a further aspect of the disclosure, there is provided method of controllably reflecting electromagnetic (EM) waves, comprising: determining an angle of incidence of EM waves relative to the metasurface comprising an array of electromagnetic unit cells; determining a desired anomalous angle of reflection of the EM waves relative to the metasurface; and controlling, based on the angle of incidence of the EM waves relative to the metasurface, and based on the desired anomalous angle of reflection of the EM waves relative to the metasurface, a reflection phase of each unit cell of a supercell of the metasurface to control an angle of reflection of the EM waves relative to the metasurface to be the desired anomalous angle of reflection, wherein the supercell consists of one or more of the unit cells, and wherein a size (D) of the supercell in a direction of propagation of the EM waves is at least 2λ, wherein λ is a wavelength of the EM waves.

According to a further aspect of the disclosure, there is provided a computer-readable medium have stored thereon computer program code configured, when executed by one or more processors, to cause the one or more processors to perform a method comprising: determining an angle of incidence of EM waves relative to a metasurface comprising an array of electromagnetic unit cells; determining a desired anomalous angle of reflection of the EM waves relative to the metasurface; and controlling, based on the angle of incidence of the EM waves relative to the metasurface, and based on the desired anomalous angle of reflection of the EM waves relative to the metasurface, a reflection phase of unit cell of a supercell of the metasurface to control an angle of reflection of the EM waves relative to the metasurface to be the desired anomalous angle of reflection, wherein the supercell consists of one or more of the unit cells, and wherein a size (D) of the supercell in a direction of propagation of the EM waves is at least 2λ, wherein λ is a wavelength of the EM waves.

According to a further aspect of the disclosure, there is provided an apparatus, wherein the apparatus is within the device described in the first aspect.

According to a further aspect of the disclosure, there is provided a system, wherein the system comprises the device described in the first aspect or the apparatus described above.

This summary does not necessarily describe the entire scope of all aspects. Other aspects, features and advantages will be apparent to those of ordinary skill in the art upon review of the following description of specific embodiments.

### BRIEF DESCRIPTION OF THE DRAWINGS

Embodiments of the disclosure will now be described in detail in conjunction with the accompanying drawings of which:

FIG. 1 is a schematic diagram of a controller controlling a metasurface, according to an embodiment of the disclosure;

FIG. 2 shows an example of a reconfigurable metasurface comprising an array of unit cells and supercells, according to an embodiment of the disclosure;

FIG. 3 shows an isometric view of a supercell of the metasurface of FIG. 2;

FIG. 4 is a schematic diagram of a holographic anomalous reflector being used to anomalously reflect electromagnetic waves, according to an embodiment of the disclosure;

FIG. 5 is a schematic diagram of a supercell of a reconfigurable metasurface being used to anomalously reflect electromagnetic waves, according to an embodiment of the disclosure;

FIG. 6 is a plot of TM mode electric field patterns of an array of ten supercells, with D=60 mm and β=15°, according to an embodiment of the disclosure;

FIG. 7 is a plot of incident and scattered field patterns for varying angles of incidence, with D=60 mm, according to an embodiment of the disclosure;

FIG. 8 is a plot of scattered field patterns for supercells of various sizes D, and with a fixed angle of incidence, according to an embodiment of the disclosure;

FIG. 9 is a plot of incident and scattered TM mode electric field patterns of an array of ten supercells, according to an embodiment of the disclosure;

FIG. 10 is a plot of TM mode electric field patterns reflected from a virtual perfect electric conductor (PEC) reflector and from a corresponding holographic metasurface, according to an embodiment of the disclosure;

FIG. 11 is a plot of TE mode electric field patterns reflected from a virtual PEC reflector and from a corresponding holographic metasurface, according to an embodiment of the disclosure;

FIG. 12 shows an example of a reconfigurable metasurface comprising an array of unit cells and with rows of offset supercells, according to an embodiment of the disclosure;

FIG. 13 is a plot of a radiation pattern reflected from a metasurface with non-offset rows of supercells, according to an embodiment of the disclosure; and

FIG. 14 is a plot of a radiation pattern reflected from a metasurface with offset rows of supercells, according to an embodiment of the disclosure.

### DETAILED DESCRIPTION

The present disclosure seeks to provide an electronically reconfigurable metasurface that may provide relatively wide-angle anomalous EM reflections. While various embodiments of the disclosure are described below, the disclosure is not limited to these embodiments, and variations of these embodiments may well fall within the scope of the disclosure which is to be limited only by the appended claims.

Throughout the disclosure, a metasurface, according to some embodiments, may refer to a surface comprising artificially designed sub-wavelength structures for controlling or manipulating the scattering properties of electromagnetic waves incident on the metasurface. In this context, according to some embodiments, throughout this disclosure the term meta-mirror may refer to a metasurface designed to reflect an incident plane wave into a reflected plane wave propagating in a different and arbitrary direction of interest.

According to embodiments of the present disclosure, an incoming electromagnetic (EM) wave can be redirected to an arbitrary reflection direction without use of active RF components. For example, embodiments may allow for the control of reflection directions of incoming EM waves over a wide separation angle of over 120° (the separation angle being the angle formed between the direction of propagation of the incident waves and the direction of propagation of the reflected waves). A metasurface according to embodiments described herein may be extremely low-profile (for example, less than a few millimeters for microwave to millimeter-wave applications) and may be quickly reconfigured for low-cost, large-scale channel optimization of future cellular networks. As a result, a metasurface according to embodiments described herein may increase channel capacity by orders of magnitude without significant increase in power consumption, and may thereby significantly improve both spectral and energy efficiency of a communications channel.

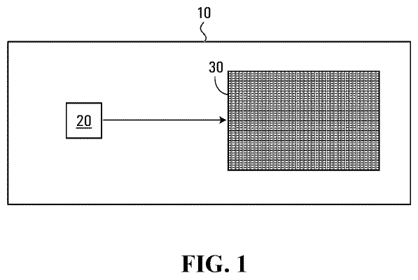

FIG. 1 shows an example device 10 for controllably reflecting electromagnetic waves, according to an embodiment of the disclosure. Device 10 comprises a controller 20 and a metasurface 30. Controller may be, for example, any suitable kind of microcontroller with Field Programmable Gate Array (FPGA) circuitry or Application-Specific Integrated Circuit (ASIC) components. According to some embodiments, controller 20 may be integrated directly with metasurface 30 such that the two may form a single module, whereas according to other embodiments controller 20 may be separate from and remote from metasurface 30.

As described in further detail below, metasurface 30 comprises a two-dimensional array of electronically programmable metamaterial unit cells. Each unit cell includes one or more artificially-designed subwavelength structures or materials for interacting with EM waves incident thereon. In particular, the phase of a reflected EM wave may be modulated as a result of the incident wave interacting with the artificially-designed subwavelength structures or metamaterial of a unit cell. Controller 20 is operable to control the artificially-designed subwavelength structures or metamaterial of the unit cells, so as to controllably adjust the way in which the phase of a reflected EM wave may be modulated as a result of the incident wave interacting with a unit cell. As a result, controller 20 may indirectly control the scattering properties of EM waves incident on metasurface 30, as described in further detail below. Such control over the artificially-designed subwavelength structures or metamaterial may be referred to as controlling the reflection phase (which may also be referred to as the reflection or scattering coefficient) of the unit cell. By selectively controlling the reflection phase of each unit cell in a particular group of unit cells of metasurface 30 (the group being referred to as a “supercell” of unit cells), controller 20 is able to control the angle of reflection of EM waves incident on metasurface 30. In particular, the angle of reflection of the EM waves relative to metasurface 30 may be controlled such that the angle of reflection is set to a desired anomalous angle of reflection. An anomalous angle of reflection is an angle of reflection when an incident ray is redirected to an arbitrary reflection direction, and may or may not be equal to the angle of incidence.

According to some embodiments, each unit cell in the supercell may be controlled by the controller to have the same reflection phase. According to other embodiments, each unit cell in the supercell may be controlled by the controller to have a different reflection phase, with the supercell having an overall average reflection phase based on the individual reflection phase of each unit cell that makes up the supercell.

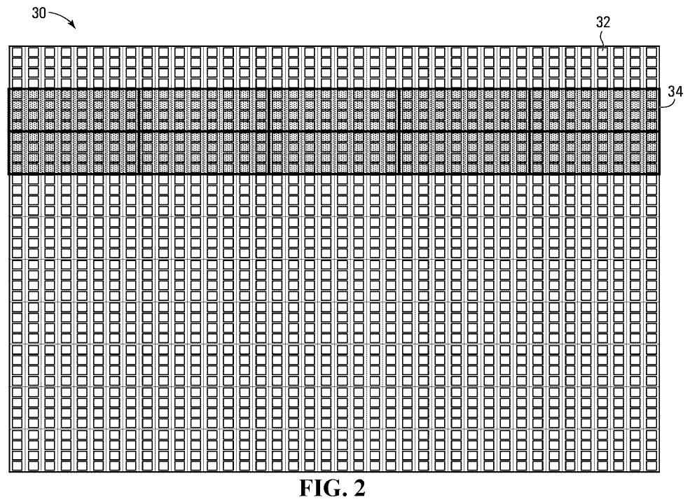

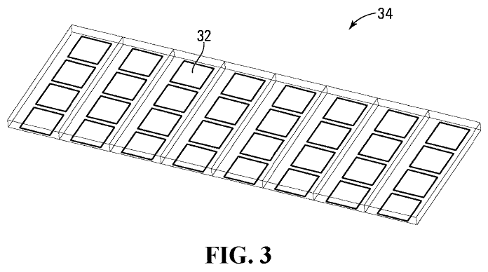

FIG. 2 shows an example of metasurface 30 that may be used as a holographic meta-mirror for the purposes of anomalously reflecting EM waves. Metasurface 30 comprises a two-dimensional array of unit cells 32. A group of unit cells 32 that is controlled by controller 20 in order to controllably reflect the EM waves is referred to as a supercell 34. Controller 20 may control multiple different groups of unit cells 32, and may therefore control multiple supercells 34. As can be seen in FIG. 2, metasurface 30 comprises rows of non-offset supercells 34. FIG. 3 shows one such supercell 34 in more detail.

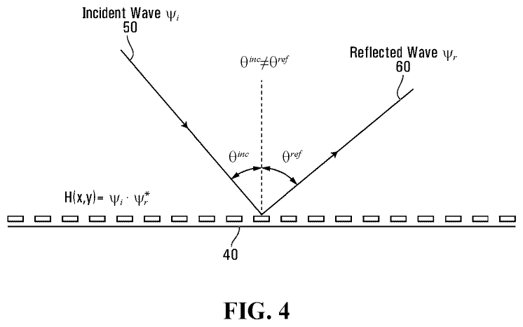

In the particular example of FIGS. 3 and 4, unit cells 32 are square patches of equal size and evenly spaced from one another, to be used for dual-polarized wave propagations. However, unit cells with other geometrical shapes may be used, such as circular or elliptical unit cells, depending for example on the properties of the incident EM waves. In order to enable rapidly-variable reflection phases, unit cells 32 are designed to incorporate any of various electronically adjustable mechanisms, such as a liquid crystal loaded dielectric material, microelectromechanical systems (MEMS), or semi-conductors for electronic phase adjustment. According to some embodiments, discretization within each supercell 34 should be sufficiently large such that the dimension of each unit cell 32 is less than 2λ. Therefore, a minimum of N=8 is generally required leading to a supercell size of at least 2λ in order to enable relatively wide-angle anomalous reflections, as described in further detail below.

Turning to FIG. 4, there is now shown the general concept of anomalous reflection, in which an incoming incident wave 50, in response to striking a reflector 40, is redirected into a reflected wave 60 in an arbitrary direction. If reflector 40 is a perfect electric conductor (PEC), the angle of reflection θ_{ref} is equal to the opposite of the angle of incidence θ_{inc}. For anomalous reflections, however, it is desired to redirect incident wave 50 according to some other direction of interest, which in general is not equal to the opposite of the angle of incidence. Furthermore, according to anomalous reflections, the separation angle between incident wave 50 and reflected wave 60 can be well over 90°.

According to embodiments of the disclosure, reflector 40 is a metasurface comprising, as described above, a periodic array of supercells of relatively large dimension (>2λ in the direction of the plane of propagation of the incident and reflected waves). Furthermore, the dimension of the supercells is set to be relatively large to enable more than three modes of propagation, and typically at least five modes of propagation, depending on the required separation angle between incident wave 50 and reflected wave 60.

For optimum efficiency of energy redirection over a relatively wide angle, from an incident wave, di, to a reflected wave, dr, a phase hologram is determined for the unit cells within the supercell. The phase hologram may define a pattern on a metasurface and contains amplitude and phase information representing an interference pattern between two waves. This pattern defined by the phase hologram may allow for a wave incident on the metasurface to be redirected to a desired direction. The phase hologram is based on the characteristics of the incident and reflected waves:

$$H ( x , y ) - {ψ}_{i} \cdot {ψ}_{r}^{*} \qquad ( 1 )$$

H is the phase hologram in units of radians. Controller 20 may therefore determine an algorithm for controlling the reflection phase of each individual unit cell 32 within a supercell 34 of metasurface 30. Controller 20 may therefore produce a periodic holographic metasurface that is designed to transport the incident energy along metasurface 30 and re-radiate the transported energy progressively along the surface within each supercell 34.

It shall be understood that, by controlling each unit cell 32 of supercell 34, this includes controlling the reflection phase of one or more unit cells 32 of supercell 34 such that the reflection phase is increased or decreased, as well as controlling the reflection phase of one or more unit cells 32 of supercell 34 such that the reflection phase is neither increased nor decreased but rather is kept constant.

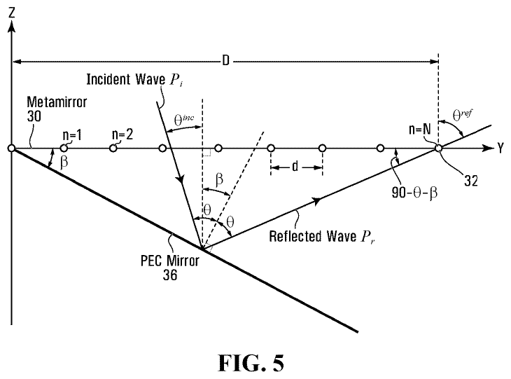

In order to demonstrate this concept, a derivation for a simple case of plane wave propagation in the YZ direction is shown in FIG. 5, which shows an analytical model of the above-described reconfigurable meta-mirror supercell. In this example, ray tracing using a virtual PEC surface 36 set at a tilt angle β can be used to produce such a phase hologram. Note that for more general cases of reflections in desired anomalous directions, PEC surface 36 can be of a more complex shape such as a wedge, a paraboloid, or a sphere.

Each supercell 34 of meta-mirror 30 is discretized into N point unit cells 32 and has an overall dimension D in the propagation direction of the incident wave. Spacing between unit cells 32 is d=D/N. The required incident angle (θ^{inc}) and reflection angle (θ^{ref}) measured at the surface of meta-mirror 30 can be related to the PEC tilt angle β, as well as the incident and specular reflection angles θ of PEC surface 36 as follows:

$${θ}^{inc} = θ - β \qquad ( 2 )$$

$${θ}^{ref} = - ( θ + β ) \qquad ( 3 )$$

$$( {θ}^{ref} - {θ}^{inc} ) = 2 θ \qquad ( 4 )$$

A phase hologram, representing the average reflection phase at the center of each unit cell 32 of supercell 34, can then be estimated by ray tracing. For simplicity, this derivation assumes one-dimensional wave propagation in the ZY plane only. The total phase delay at the center of each unit cell 32 is estimated using the total sum of the path lengths of the incident and reflected waves:

$$H = \frac{2 π}{λ} \cdot ( {P}_{i} + {P}_{r} ) , where {P}_{r} = nd \cdot \frac{sin ( β )}{Cos ( θ )} , and {P}_{i} \cdot = nd \cdot \frac{sin ( β )}{Cos ( θ )} \cdot \frac{Cos ( θ + β )}{Cos ( θ - β )} \qquad ( 5 )$$

Through mathematical manipulations using trigonometry, the phase hologram can be reduced to:

$$H = \frac{2 π nd}{λ} \cdot [ 1 + \frac{Cos ( θ + β )}{Cos ( θ - β )} ] [ \frac{Sin ( β )}{Cos ( θ )} ] \qquad ( 6 )$$

This formula represents a phase hologram which will redirect an incident wave with angle θ^{inc} into an arbitrary reflection angle θ^{ref}, once the tilt angle β and the specular reflection angle θ of PEC surface 36 are specified.

By using the above expression for H, controller 20 may control the reflection phase of each unit cell 32 comprised in supercell 34 in order to control the angle of reflection of the incoming waves to be equal to a desired anomalous angle of reflection. The angle of incidence of the waves, and the desired anomalous angle of reflection, may be user-specified inputs to the controller 20 that controller 20 then uses in its calculation of the phase hologram.

The tilt angle β of PEC surface 36 can be determined by setting the initial angle of incidence, θ^{inc}, to 0° and by defining the resultant reflection angle as θ^{ref}=θ⁰ which represents the reflection angle at normal incidence. Accordingly, based on (2) and (3), and θ=β:

$$β = - \frac{1}{2} {θ}^{0} \qquad ( 7 )$$

The angle of reflection at normal incidence can then be determined by substituting (7) back into (2) and (3):

$${θ}^{0} = {θ}^{inc} + {θ}^{ref} \qquad ( 8 )$$

The specular angle of reflection at PEC surface 36 can be determined from (2):

$$θ = {θ}^{inc} + β \qquad ( 9 )$$

One other parameter of interest is the overall size, D, of supercell 34, which is determined by the angle of reflection at normal incidence since the incidence is set to 0°, i.e.:

$$D = \frac{λ}{\vert Sin ( {θ}^{0} ) \vert} \qquad ( 10 )$$

In order to allow propagations in at least five modes (0, ±1 and ±2), D should be sufficiently large. Typically, D is of the order of two free-space wavelengths or slightly larger. In addition, the greater the size of the supercell, the greater the permissible angular separation between the angle of incidence and the angle of reflection, although the greater the degradation in overall redirection efficiency.

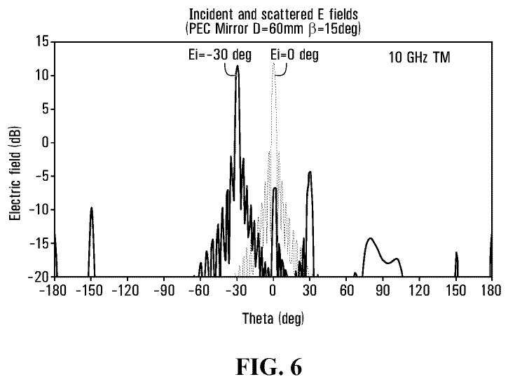

The above-described method of controlling a metasurface to controllably and anomalously reflect incoming EM waves has been demonstrated using a virtual PEC reflector with supercell size D=60 mm and a tilt angle β=15°. FIG. 6 shows TM mode incident and scattered electric field patterns from a series array of ten supercells when the angle of incidence is 0°. In this case, the angle of reflection at normal incidence is −30°.

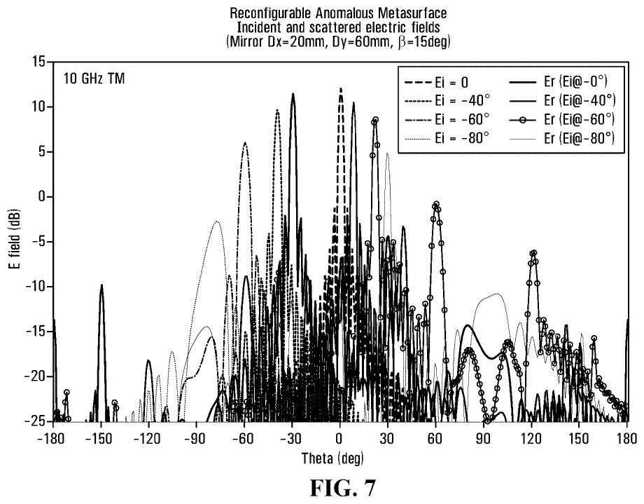

FIG. 7 shows TM mode incident and scattered electric field patterns from the array of ten supercells of FIG. 6, with the angle of incidence varying from 0° to −80° for the same supercell size of D=60 mm. Interestingly, as the angle of incidence varies from 0° to −80°, the scattered field pattern moves from −30° to −30°, in the opposite direction. These radiation patterns are reciprocal, i.e. the incident and scattered field angles are interchangeable. As the plot shows, the amplitude of the field patterns tapers off at the rate of a cosine factor, with a peak at −15° (β) whereat the electric field is completely retro-reflected.

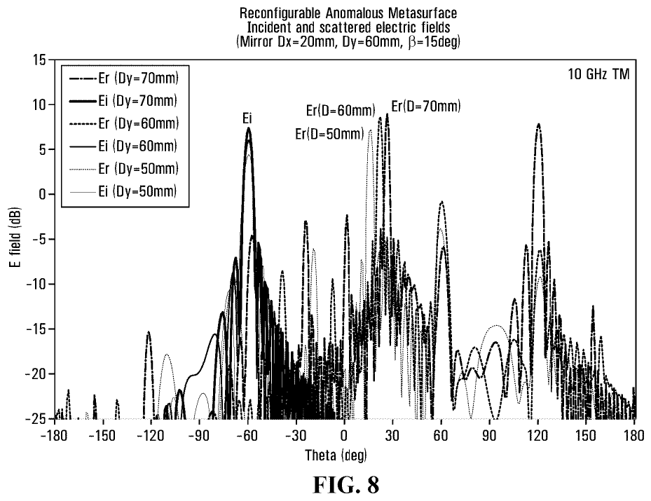

FIG. 8 shows the effect of varying the supercell size D while the angle of incidence remains fixed at minus 60°. These results show that the angle of reflection increases from 15° to about 28° as the supercell size D varies from 50 mm to 70 mm. However, the sidelobes and grating lobes also increase as the supercell size increases. Eventually, an overly large supercell size may result in power losses due to grating lobes and sibelobes.

These results show that the described meta-mirror can be designed to accomplish anomalous reflection for a relatively wide separation angle of up to 120°. The change in reflection angle can be accomplished by either varying the supercell size D or by adjusting the tilt angle β of the virtual PEC reflector.

Advantageously, the above-described holographic meta-mirror, comprised of electronically phase-tunable unit cells, may be instantaneously reconfigurable for different anomalous angles of reflection. The following demonstrates the design of the holographic meta-mirror for wide-angle anomalous reflection. In this example, each supercell has a dimension of 30 mm and 88 mm in the x and y directions, respectively. The operating frequency is 10 GHZ, or λ=30 mm. The required incidence and reflection angles are θ^{inc}=−30° and θ^{ref}=50°, respectively. The required parameters of the meta-mirror can be determined following equations (7) to (10) as follow:
(1) Reflection angle at zero-degree incidence, θ⁰=θ^{inc}+θ^{ref}=20°
(2) Tilt angle of the virtual PEC mirror, β=−θ⁰/2=−10°
(3) Specular reflection angle of the virtual PEC mirror, θ=θ^{inc}+β=−40°
(4) Required size for each supercell,

$${D}_{y} = \frac{λ}{\vert Sin ( {θ}^{0} ) \vert} = 88 mm \approx 2.93 λ$$

(5) Phase hologram (described below)

With D=about 2.93λ, the supercell size is sufficiently large to give the required modes of wave propagation. The supercell is discretized into N=8 unit cells in the y direction and N=4 in the x direction. Dielectric-loaded square patches (6.5 mm square) are used here as an example to achieve the required reflection phases. The relative phase and dielectric constants required to produce the phase hologram are listed as Table 1.

TABLE 1

| m | Reflection | εᵣ |
|---|---|---|
| 1 | 0 | 1 |
| 2 | −52 | 2.1 |
| 3 | −104 | 2.6 |
| 4 | −156 | 3.2 |
| 5 | −208 | 3.8 |
| 6 | −260 | 5.4 |
| 7 | −312 | 12.5 |
| 8 | −360 | 1 |

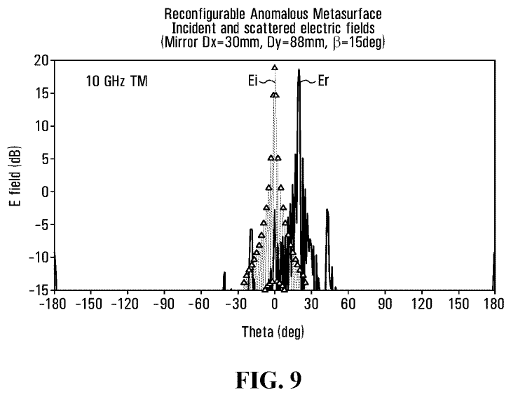

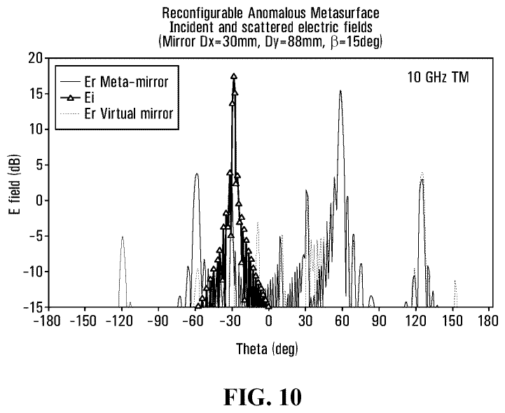

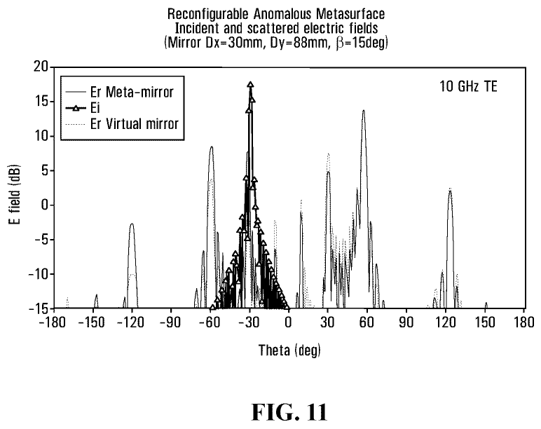

FIG. 9 shows simulated incident and scattered field patterns for transverse magnetic incidence at 0°. FIGS. 10 and 11 compare transverse magnetic and transverse electric incident and scattered field patterns from a virtual PEC reflector and from a corresponding holographic meta-mirror. As these plots shows, the designed meta-mirror is able to achieve the required anomalous reflection. Furthermore, the scattered field patterns produced by these two methods are closely related.

As mentioned above, one drawback with the above design is the tendency for it to produce unwanted sidelobes. Significantly improved sidelobe performance can be achieved by using a meta-mirror with staggered or offset rows of supercells. This may improve the overall redirection efficiency of the meta-mirror.

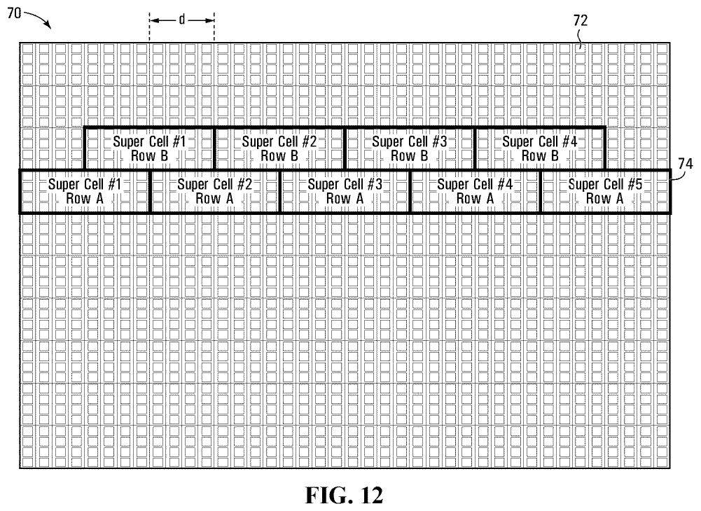

FIG. 12 shows this alternative configuration according to another embodiment of the disclosure. In particular, there is shown a metasurface 70 comprising unit cells 72 and rows of offset supercells 74 defined by groups of unit cells 72. The properties of each supercell 74 remain the same as described above. However, according to this embodiment, each row of supercells 74 is offset from an adjacent row of supercells 74 by an offset distance d in the direction of the scattered waves. The optimum offset distance d, which may be determined numerically, depends on the direction of reflection θ^{ref}. In most instances, an offset distance of half the supercell size (i.e. one wavelength for a supercell of approximately two wavelengths) yields a significant reduction in the sidelobes of the scattered field pattern. To achieve the desired sidelobe reduction without affecting the main-lobe gain, a suitable amount of phase offset should also be introduced to all supercells in every other row of supercells. The optimum phase offset is generally a function of the offset distance, and can be determined numerically. For example, for an offset distance of about one wavelength, the optimum phase offset is close to 180°.

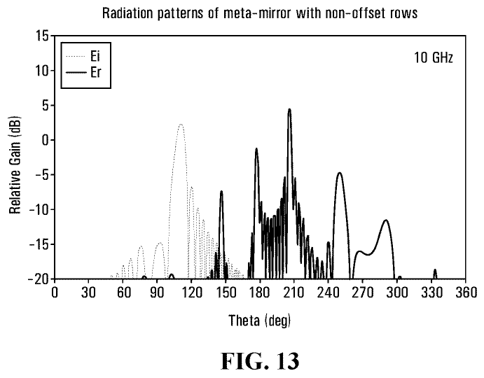

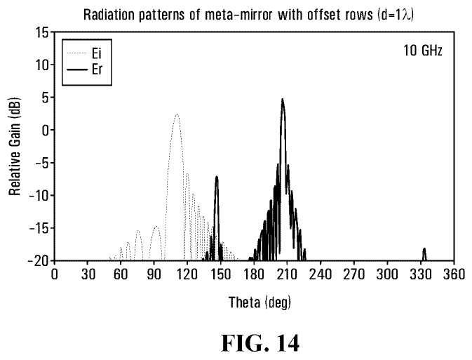

FIGS. 13 and 14 give a comparison of resultant scattered radiation patterns for a meta-mirror with non-offset supercells and a meta-mirror with offset supercells. In this case, the size D of each supercell is 2λ and the offset distance is d=λ. The offset phase between every other row of supercells is 180°. As shown in the FIG. 14, most sidelobes disappeared to below the −20 dB level. This result is desirable since both the overall redirection efficiency within the supecell is improved and interference between neighboring supercells are decreased.

The power redirection efficiency of the meta-mirror can be assessed using a power conversion factor ξᵣ(θ^{inc}, θ^{ref}) from the incident wave θ^{inc} to the reflected wave θ^{ref}, excluding possible beam broadening due to aperture cosine angles:

$${ξ}_{r} ( {θ}^{inc} , {θ}^{ref} ) = \frac{{\vert {E}^{ref} \vert}^{2}}{{\vert {E}^{inc} \vert}^{2}} \cdot {\vert \frac{Cos ( {θ}^{ref} )}{Cos ( {θ}^{inc} )} \vert}^{- 1} \qquad ( 11 )$$

This loss factor is purposely defined to include all losses due to redirection of the incident wave, including absorption loss in the reflecting surface and all unintended radiation in sidelobes and grating lobes of the reflected waves, except for beam broadening due to the cosine angles of the incident and reflected waves. Table 2 compares the redirection efficiencies for a meta-mirror with non-offset supercells and for a meta-mirror with offset supercells. The loss factor is −1.35 dB (73%) for the non-offset meta-mirror and is improved to −0.96 dB (80%) for the offset meta-mirror. The improved efficiency for the offset meta-mirror is evidently due to the much lower sidelobes in the unwanted reflections. This result is consistent with the field patterns presented in FIGS. 13 and 14.

TABLE 2

| | TM Case | TM Case |
|---|---|---|
| | Non-offset | Offset |
| | supercell rows | supercell rows |
| Parameter | (d = 0) | (d = 1λ) |
| θ^{ref} (deg) | +26 | +26 |
| θ^{inc} (deg) | −70 | −70 |
| \|Cos(θ^{ref})\| (dB) | 0.8988 | 0.8988 |
| \|Cos(θ^{inc})\| (dB) | 0.3420 | 0.3420 |
| $\vert \frac{Cos ( {θ}^{ref} )}{Cos ( {θ}^{inc} )} \vert ( dB )$ | 4.1961 | 4.1961 |
| \|Eⁱ\|² (dB) | 8.719 | 8.719 |
| \|E^{r}\|² (dB) | 11.570 | 11.958 |
| ξᵣ (θ^{inc}, θ^{ref}) (dB) | −1.35 | −0.96 |
| ξᵣ (%) | 73 | 80 |

Generally, there has been described the concept of an electronically reconfigurable holographic meta-mirror that comprises multiple reconfigurable holographic supercells. A phase hologram for each supercell can be generated using a virtual PEC reflector. The meta-mirror can be used to redirect an incident EM wave into any arbitrary direction with a relatively wide separation angle of up to 120°. The holographic meta-mirror is reconfigurable using any of various electronic methods, such as liquid crystal loading, MEMS, and/or semi-conductors. The holographic meta-mirror may be fully passive without the need for active RF components, and can be easily deployed in urban settings with high-rises and other tall building structures. This enables significant improvement both in spectral and energy efficiency for future cellular communications.

Embodiments described herein have the potential for many applications in the fields of wireless communications and radar, as well as the aerospace industry. For example, reconfigurable metasurfaces may be used in communications for passive reconfigurable arrays, extremely large aperture arrays (ELAA), or large intelligent surfaces (LIS). The technology can also be used for the optimization and calibration of a satellite communication channel.

Embodiments described herein may be used in “smart skins” for stealth aircraft or radar applications. In such cases, the meta-mirror can be used to reduce the radar cross-section of an aircraft. Embodiments described herein may also be used in multi-input and multi-output (MIMO) wireless networks, and the meta-mirror may be installed anywhere as a low-cost alternative to improve MIMO channel performances.

The word “a” or “an” when used in conjunction with the term “comprising” or “including” in the claims and/or the specification may mean “one”, but it is also consistent with the meaning of “one or more”, “at least one”, and “one or more than one” unless the content clearly dictates otherwise. Similarly, the word “another” may mean at least a second or more unless the content clearly dictates otherwise.

The terms “coupled”, “coupling” or “connected” as used herein can have several different meanings depending on the context in which these terms are used. For example, as used herein, the terms coupled, coupling, or connected can indicate that two elements or devices are directly connected to one another or connected to one another through one or more intermediate elements or devices via a mechanical element depending on the particular context. The term “and/or” herein when used in association with a list of items means any one or more of the items comprising that list.

As used herein, a reference to “about” or “approximately” a number or to being “substantially” equal to a number means being within +/−10% of that number.

While the disclosure has been described in connection with specific embodiments, it is to be understood that the disclosure is not limited to these embodiments, and that alterations, modifications, and variations of these embodiments may be carried out by the skilled person without departing from the scope of the disclosure.

It is furthermore contemplated that any part of any aspect or embodiment discussed in this specification can be implemented or combined with any part of any other aspect or embodiment discussed in this specification.

1. A device for controllably reflecting electromagnetic (EM) waves, comprising:
a metasurface comprising an array of electromagnetic unit cells; and
a controller for controlling, based on an angle of incidence of the EM waves relative to the metasurface and based on a desired anomalous angle of reflection of the EM waves relative to the metasurface, a reflection phase of each unit cell of a supercell of the metasurface to control an angle of reflection of the EM waves relative to the metasurface to be the desired anomalous angle of reflection, and
wherein the supercell consists of one or more of the unit cells, and wherein a size (D) of the supercell in a direction of a plane of propagation of the EM waves is at least 2λ, wherein λ is a wavelength of the EM waves.

2. The device of claim 1, wherein D is equal to λ/|sin θ⁰|, wherein θ⁰ is the angle of incidence the EM waves relative to the metasurface.

3. The device of claim 1, wherein controlling the reflection phase of each unit cell of the supercell comprises determining
$$H = \frac{2 π nd}{λ} \cdot [ 1 + \frac{cos ( θ + β )}{cos ( θ - β )} ] [ \frac{sin β}{cos θ} ] ,$$
wherein:
H is a phase hologram representing an average reflection phase at a center of each unit cell of the supercell;
d is an inter-element spacing separating adjacent unit cells of the supercell;
n is a positive integer;
β is an angle between the metasurface and a virtual reflective surface, wherein the virtual reflective surface is a reflective surface wherein, if the EM waves were incident on the reflective surface, the EM waves would be reflected in a same direction as the EM waves are to be anomalously reflected off the metasurface; and
θ is, if the EM waves were incident on the reflective surface, a specular angle of reflection of the EM waves relative to the reflective surface.

4. The device of claim 1, wherein each unit cell of the supercell comprises one or more artificially engineered structures for interacting with the EM waves.

5. The device of claim 4, wherein the one or more artificially engineered structures comprise one of more of: a liquid crystal loaded dielectric material; a microelectromechanical system (MEMS); and a semi-conductor for electronic phase adjustment.

6. The device of claim 1, wherein a size of each unit cell of the supercell is less than Δ/4.

7. The device of claim 1, wherein:
the controller is operable, based on the angle of incidence of the EM waves relative to the metasurface, and based on the desired anomalous angle of reflection of the EM waves relative to the metasurface, to control the reflection phase of each of first unit cells of the unit cells, and each of second unit cells of the unit cells, so as to control the angle of reflection of the EM waves relative to the metasurface to be the desired anomalous angle of reflection;
the first unit cells define a first row of one or more first supercells, each first supercell comprising one or more first unit cells;
the second unit cells define a second row of one or more second supercells, each second supercell comprising one or more second unit cells; and
the first row of one or more first supercells is, in the direction of the plane of propagation of the EM waves, offset by an offset distance from the second row of one or more second supercells.

8. The device of claim 7, wherein the offset distance is less than half a size of the supercell in the direction of the plane of propagation of the EM waves, and less than λ.

9. The device of claim 7, wherein controlling the reflection phase of each first unit cell and each second unit cell comprises determining the reflection phase of each unit cell of each first supercell and each second supercell based on the offset distance.

10. The device of claim 1, wherein a separation angle between the angle of incidence of the EM waves relative to the metasurface and the desired anomalous angle of reflection of the EM waves relative to the metasurface is at least 120°.

11. A method of controllably reflecting electromagnetic (EM) waves, comprising:
determining an angle of incidence of EM waves relative to the metasurface comprising an array of electromagnetic unit cells;
determining a desired anomalous angle of reflection of the EM waves relative to the metasurface; and
controlling, based on the angle of incidence of the EM waves relative to the metasurface, and based on the desired anomalous angle of reflection of the EM waves relative to the metasurface, a reflection phase of each unit cell of a supercell of the metasurface to control an angle of reflection of the EM waves relative to the metasurface to be the desired anomalous angle of reflection,
wherein the supercell consists of one or more of the unit cells, and wherein a size (D) of the supercell in a direction of propagation of the EM waves is at least 2λ, wherein λ is a wavelength of the EM waves.

12. The method of claim 11, wherein D is equal to λ/|sin θ⁰|, wherein θ⁰ is the angle of incidence the EM waves relative to the metasurface.

13. The method of claim 11, wherein determining the reflection phase of each unit cell of the supercell comprises determining
$$H = \frac{2 π nd}{λ} \cdot [ 1 + \frac{cos ( θ + β )}{cos ( θ - β )} ] [ \frac{sin β}{cos θ} ] ,$$
wherein:
H is a phase hologram representing an average reflection phase at a center of each unit cell of the supercell;
d is an inter-element spacing separating adjacent unit cells of the supercell;
n is a positive integer;
β is an angle between the metasurface and a virtual reflective surface, wherein the virtual reflective surface is a reflective surface wherein, if the EM waves were incident on the reflective surface, the EM waves would be reflected in a same direction as the EM waves are to be anomalously reflected off the metasurface; and
θ is, if the EM waves were incident on the reflective surface, a specular angle of reflection of the EM waves relative to the reflective surface.

14. The method of claim 11, wherein each unit cell of the supercell comprises one or more artificially engineered structures for interacting with the EM waves, and wherein a size of each unit cell of the supercell is less than λ/4.

15. The method of claim 14, wherein the one or more artificially engineered structures comprise one of more of: a liquid crystal loaded dielectric material; a microelectromechanical system (MEMS); and a semi-conductor for electronic phase adjustment.

16. The method of claim 11, wherein:
controlling the reflection phase of each of the one or more unit cells comprises controlling the reflection phase of each of first unit cells of the unit cells, and second unit cells of the unit cells;
the first unit cells define a first row of one or more first supercells, each first supercell comprising one or more first unit cells;
the second unit cells define a second row of one or more second supercells, each second supercell comprising one or more second unit cells; and
the first row of one or more first supercells is offset by an offset distance from the second row of one or more second supercells.

17. The method of claim 16, wherein the offset distance is less than half a size of the supercell in the direction of the plane of propagation of the EM waves, and less than λ.

18. The method of claim 16, further comprising determining the reflection phase of each unit cell of each first supercell and each second supercell based on the offset distance.

19. The method of claim 11, wherein a separation angle between the angle of incidence of the EM waves relative to the metasurface and the desired anomalous angle of reflection of the EM waves relative to the metasurface is at least 120°.

20. A computer-readable medium having stored thereon computer program code configured, when executed by one or more processors, to cause the one or more processors to perform a method comprising:
determining an angle of incidence of EM waves relative to a metasurface comprising an array of electromagnetic unit cells;
determining a desired anomalous angle of reflection of the EM waves relative to the metasurface; and
controlling, based on the angle of incidence of the EM waves relative to the metasurface, and based on the desired anomalous angle of reflection of the EM waves relative to the metasurface, a reflection phase of unit cell of a supercell of the metasurface to control an angle of reflection of the EM waves relative to the metasurface to be the desired anomalous angle of reflection,
wherein the supercell consists of one or more of the unit cells, and wherein a size (D) of the supercell in a direction of propagation of the EM waves is at least 2λ, wherein λ is a wavelength of the EM waves.
